(19) United States
(12) Patent Application Publication
(10) Pub. No.: US 2023/0373510 A1
(43) Pub. Date: Nov. 23, 2023

(54) COMPUTATION APPARATUS AND VEHICLE

(71) Applicant: HONDA MOTOR CO., LTD., Tokyo (JP)

(72) Inventors: Toraki IWAMARU, Tokyo (JP); Ryo TAKECHI, Tokyo (JP); Kazuki AKAMI, Tokyo (JP); Masao YOSHINAGA, Tokyo (JP)

(21) Appl. No.: 18/228,299

(22) Filed: Jul. 31, 2023

Related U.S. Application Data
(63) Continuation of application No. PCT/JP2022/000209, filed on Jan. 6, 2022.

(30) Foreign Application Priority Data
Mar. 2, 2021 (JP) 2021-032810

(51) Int. Cl. B60W 50/14; B60W 40/02

(52) U.S. Cl. CPC B60W 50/14; B60W 40/02; B60W 2050/146; B60W 2300/36; B60W 2540/223; B60W 2540/18

(57) ABSTRACT

A computation apparatus for computing a travel route of a vehicle, the computation apparatus comprising an acquisition unit configured to acquire vehicle state information indicating a state of the vehicle, vehicle periphery information indicating a state around the vehicle, and driver state information indicating a state of a driver of the vehicle, a calculation unit configured to calculate the travel route of the vehicle based on the vehicle state information, the vehicle periphery information, and the driver state information, and a signal output unit configured to output a signal in a case where the travel route satisfies a predetermined condition, that implements more appropriate driving assistance thereby.

### CROSS-REFERENCE TO RELATED APPLICATION(S)

This application is a continuation of International Patent Application No. PCT/JP2022/000209 filed on Jan. 6, 2022, which claims priority to and the benefit of Japanese Patent Application No. 2021-032810 filed on Mar. 2, 2021, the entire disclosures of which are incorporated herein by reference.

### TECHNICAL FIELD

The present invention mainly relates to a computation apparatus.

### BACKGROUND ART

Some vehicles support driving assistance or perform automated driving by an electronic control unit (ECU) performing some or all of driving operations on behalf of a driver (see Patent Literature 1).

### CITATION LIST

### Patent Literature

PTL1: Japanese Patent Laid-Open No. 2011-159186

### SUMMARY OF INVENTION

### Technical Problem

Various forms of the driving assistance are conceivable, and there is room for improvement in the configuration described in Patent Literature 1 in implementing the various forms.

An illustrative object of the present invention is to implement more appropriate driving assistance.

### Solution to Problem

An aspect of the present invention is a computation apparatus for computing a travel route of a vehicle, the computation apparatus comprising: an acquisition unit configured to acquire vehicle state information indicating a state of the vehicle, vehicle periphery information indicating a state around the vehicle, and driver state information indicating a state of a driver of the vehicle; a calculation unit configured to calculate the travel route of the vehicle based on the vehicle state information, the vehicle periphery information, and the driver state information; and a signal output unit configured to output a signal in a case where the travel route satisfies a predetermined condition, wherein the acquisition unit further acquires confirmation motion information indicating whether or not a confirmation motion is made by the driver, the signal output unit suppresses the output of the signal based on the confirmation motion information after outputting the signal, and in a case in which the signal output by the signal output unit is set as a first notification signal for notifying the driver, and the confirmation motion is not made for a predetermined period, the signal output unit further outputs a second notification signal for notifying the driver, the second notification signal having a higher notification level than the first notification signal.

### Advantageous Effects of Invention

According to the present invention, appropriate driving assistance can be implemented.

Other features and advantages of the present invention will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a view illustrating a configuration example of a vehicle.

FIG. 2 is a flowchart illustrating an example of computational processing in a computation apparatus.

FIG. 3 is a view illustrating an example of an image displayed on a display apparatus.

FIG. 4 is a view illustrating another example of the image displayed on the display apparatus.

FIG. 5 is a view illustrating another example of the image displayed on the display apparatus.

FIG. 6 is a flowchart illustrating another example of the computational processing in the computation apparatus.

FIG. 7 is a view illustrating another example of the image displayed on the display apparatus.

FIG. 8 is a view illustrating another example of the image displayed on the display apparatus.

### DESCRIPTION OF EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

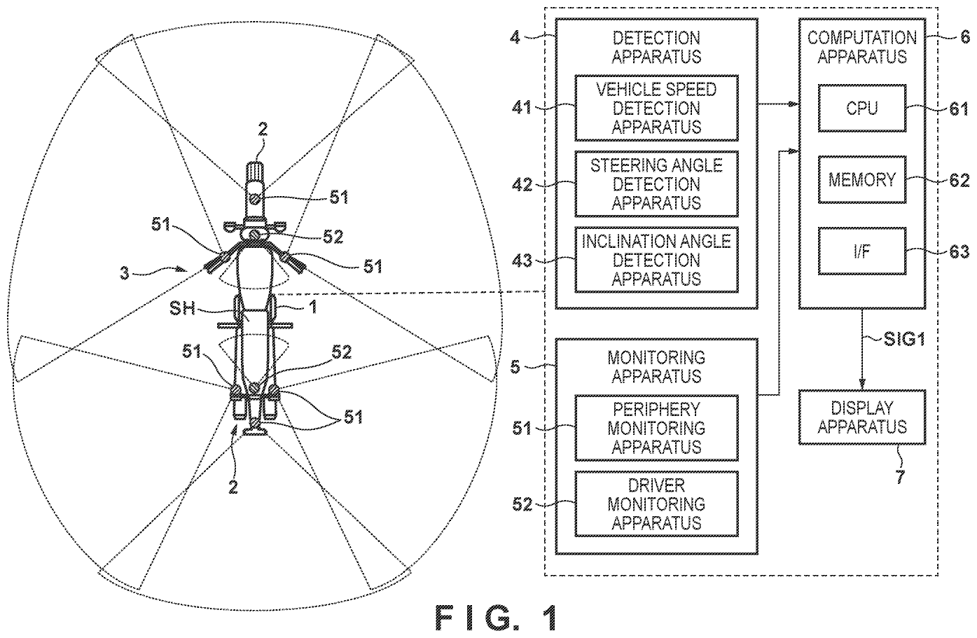

FIG. 1 is a view illustrating an example of a configuration of a vehicle 1 according to a first embodiment. The vehicle 1 is, for example, a straddled vehicle, and includes wheels 2, a steering mechanism 3, a detection apparatus 4, a monitoring apparatus 5, a computation apparatus 6, and a display apparatus 7. In the present embodiment, the vehicle 1 is a two-wheeled vehicle including two wheels 2, a single front wheel and a single rear wheel, but the number of wheels 2 is not limited thereto. As another embodiment, the vehicle 1 may be a three-wheeled vehicle, a four-wheeled vehicle, or the like.

The steering mechanism 3 is configured to change a traveling direction of the vehicle 1. In the present embodiment, the steering mechanism 3 is configured to be able to change a direction of the front wheel 2 by a handlebar, a front fork, and the like that are rotatable with respect to a vehicle body.

In the present embodiment, the detection apparatus 4 includes a vehicle speed detection apparatus 41, a steering angle detection apparatus 42, and an inclination angle detection apparatus 43. The vehicle speed detection apparatus 41 is configured to be able to detect a traveling speed of the vehicle 1. A known vehicle speed sensor may be used as the vehicle speed detection apparatus 41. The steering angle detection apparatus 42 is configured to be able to detect a steering angle of the steering mechanism 3. A known optical encoder may be used as the steering angle detection apparatus 42. The inclination angle detection apparatus 43 is configured to be able to detect an inclination of the vehicle body of the vehicle 1 as an inclination angle. A known acceleration sensor may be used as the inclination angle detection apparatus 43.

In the present embodiment, the monitoring apparatus 5 includes a periphery monitoring apparatus 51 and a driver monitoring apparatus 52. For the monitoring apparatuses 51 and 52, it is sufficient if any known imaging apparatus or distance measuring apparatus such as a camera, a millimeter wave radar, or a light detection and ranging (LiDAR) is used.

The periphery monitoring apparatus 51 is configured to be able to monitor a state around the vehicle 1 (the presence or absence of an object around the vehicle 1, a relative position thereof, or the like). The object is an object for which contact of the vehicle 1 is to be avoided, and examples of the object include other vehicles different from the vehicle (self-vehicle) 1, on-road installations, and the like. In the present embodiment, it is assumed that a plurality of periphery monitoring apparatuses 51 are provided on the vehicle body in such a way as to be able to image areas in all directions around the vehicle 1. As another embodiment, one or more peripheral monitoring apparatuses 51 may be provided in such a way as to be able to image from a front area to a side area of the vehicle 1, or in such a way as to be able to image the front area of the vehicle 1.

The driver monitoring apparatus 52 is configured to be able to monitor a driving form (a posture, a line of sight, or the like) of the driver of the vehicle 1. In the present embodiment, a pair of driver monitoring apparatuses 52 is provided in front of and behind a seat SH on which the driver sits in such a way as to be able to image the driver. In another embodiment, one or more driver monitoring apparatuses 52 may be provided in front of the seat SH in such a way as to be able to image the front face of the driver.

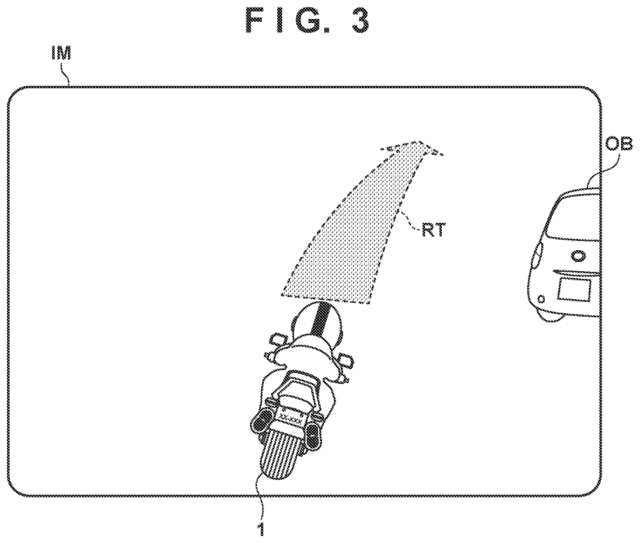

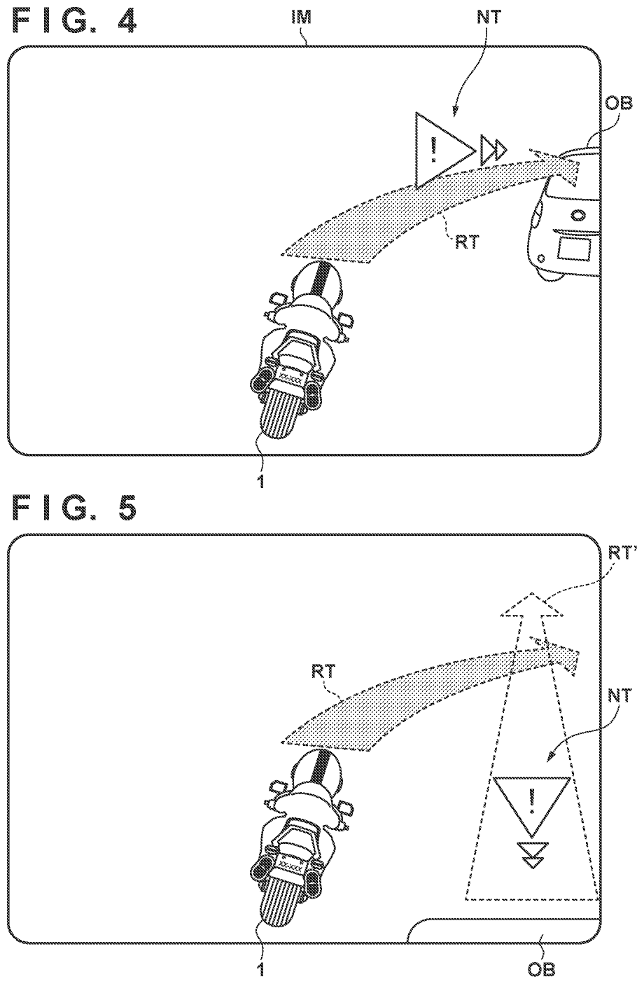

The computation apparatus 6 is configured to be able to compute a travel route RT (FIGS. 3 and 4 as described below) of the vehicle 1. In the present embodiment, a central processing unit (CPU) 61, a memory 62, and a communication interface 63 are provided, and the communication interface 63 enables communication with other elements. A computation function of the computation apparatus 6 is implemented by the CPU 61 loading a predetermined program onto the memory 62 and executing the predetermined program. As another embodiment, the computation function of the computation apparatus 6 may be implemented by an application specific integrated circuit (ASIC), that is, can be implemented by both hardware and software. A content of computational processing in the computation apparatus 6 will be described below.

The display apparatus 7 is connected to the computation apparatus 6, and can display a predetermined notification to the driver based on a signal from the computation apparatus 6. Although details will be described below, the display apparatus 7 can display the travel route RT as a computation result of the computation apparatus 6.

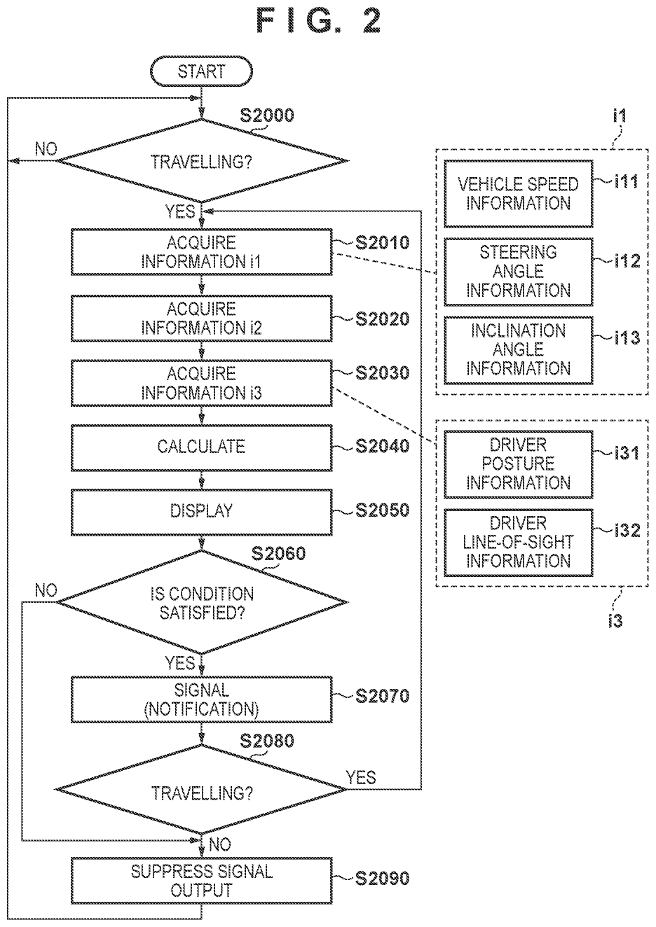

FIG. 2 is a flowchart illustrating an example of the computational processing in the computation apparatus 6. The flowchart is mainly executed by the CPU 61 and the memory 62, and an outline thereof is to calculate (or predict) the travel route RT of the vehicle 1 based on information acquired from the above-described several elements.

In step S2000 (hereinafter, simply referred to as “S2000”, and the same applies to other steps to be described below), whether or not the vehicle 1 is traveling is determined. In S2000, the CPU 61 functions as a determination unit. In a case where the vehicle 1 is traveling (in a case of Yes determination), the processing proceeds to S2010, and in the other case (in a case of No determination), the processing returns to S2000. The travel route RT calculated in the present embodiment is a trajectory predicted to be drawn by the vehicle 1 in a case where the vehicle 1 continues traveling, and in general, the trajectory can be sufficiently predicted in a case where the vehicle 1 is traveling at a speed equal to or higher than a reference speed. Details will be described below. For this reason, in the present embodiment, in a case where the speed of the vehicle 1 is equal to or higher than the reference speed, for example, in a case where the vehicle speed is equal to or higher than 30 [km/h] (30 km per hour), the processing proceeds to S2010.

In S2010, vehicle state information i1 indicating the state of the vehicle 1 is acquired. In S2010, the CPU 61 functions as an acquisition unit. In the present embodiment, the vehicle state information i1 includes vehicle speed information i11, steering angle information i12, and inclination angle information i13. The vehicle speed information i11 indicates the speed of the vehicle 1 and is acquired based on the detection result of the vehicle speed detection apparatus 41. The steering angle information i12 indicates the steering angle of the vehicle 1 and is acquired based on the detection result of the steering angle detection apparatus 42. The inclination angle information i13 indicates the inclination of the vehicle body of the vehicle 1 and is acquired based on the detection result of the inclination angle detection apparatus 43.

In S2020, vehicle periphery information i2 indicating the state around the vehicle 1 is acquired. In S2020, the CPU 61 functions as the acquisition unit. The vehicle periphery information i2 is acquired based on the monitoring result of the periphery monitoring apparatus 51. In a case where the object around the vehicle 1 is an on-road installation, the object can be identified as real estate, and accordingly, the vehicle periphery information i2 may be additionally acquired based on map information.

In S2030, driver state information i3 indicating the state of the driver is acquired. In S2030, the CPU 61 functions as the acquisition unit. The driver state information i3 is acquired based on the monitoring result of the driver monitoring apparatus 52. In the present embodiment, the driver state information i3 includes driver posture information i31 and driver light-of-sight information i32. The driver posture information i31 indicates the posture of the driver, the driver line-of-sight information i32 indicates a direction of the line of sight of the driver, and both of these pieces of information i31 and i32 are acquired based on the monitoring result of the driver monitoring apparatus 52.

In S2040, the travel route RT of the vehicle 1 is calculated (or predicted) based on the vehicle state information i1, the vehicle periphery information i2, and the driver state information i3. In S2040, the CPU 61 functions as a calculation unit. The calculation of the travel route RT based on these pieces of information i1 to i3 may be performed based on a known analysis model.

As described above, the vehicle state information i1 includes the vehicle speed information i11, the steering angle information i12, and the inclination angle information i13. The trajectory predicted to be drawn by the vehicle 1 can be analyzed based on these pieces of information i11 to i13, and in general, the accuracy of the analysis of the trajectory can become higher when being closer to the vehicle 1 and can become lower when being farther from the vehicle 1.

The above-described analysis result based on the information i11 to i13 can be corrected based on the vehicle periphery information i2 and the driver state information i3. In general, it is considered that the driver performs a driving operation of the vehicle 1 in such a way as to avoid the object around the vehicle 1. Therefore, it can be said that the above-described analysis result can be corrected based on the vehicle periphery information i2. Further, as described above, the driver state information i3 includes the driver posture information i31 and the driver line-of-sight information i32, and it is possible to predict a driving operation (or the intention) that can be performed by the driver in a relatively near future according to these pieces of information i31 and i32. Therefore, it can be said that the above-described analysis result can be corrected based on the driver state information i3.

In S2050, the travel route RT calculated in S2040 is displayed on the display apparatus 7. In S2050, the CPU 61 functions as a display instruction unit. Since the calculated travel route RT is a trajectory predicted to be drawn by the vehicle 1 in a case where the vehicle 1 continues traveling, it can be said that a longer travel route RT can be calculated as the speed of the vehicle 1 increases. Therefore, a display content of the travel route RT may be changed according to the vehicle speed. For example, a long distance travel route RT may be displayed in a case where the vehicle speed is relatively high, and a short distance travel route RT may be displayed in a case where the vehicle speed is relatively low.

In addition, as described above, the accuracy of the analysis of the trajectory predicted to be drawn by the vehicle 1 can become higher when being closer to the vehicle 1 and can become lower when being farther from the vehicle 1. Therefore, the appearance (color intensity, brightness, or the like) of the travel route RT may be changed according to the distance from the vehicle 1. For example, as illustrated in FIGS. 3 and 4 to be described below, the travel route RT may be displayed in a darker color when being closer to the vehicle 1, and may be displayed in a lighter color when being farther from the vehicle 1 on the display apparatus 7.

In S2060, it is determined whether or not the travel route RT calculated in S2040 satisfies a predetermined condition. In S2060, the CPU 61 functions as the determination unit. In a case where the predetermined condition is satisfied (in a case of Yes determination), the processing proceeds to S2070, and in a case where the predetermined condition is not satisfied (in a case of No determination), the processing proceeds to S2090. The predetermined condition is, for example, a condition under which it is difficult for the vehicle 1 to avoid the object around the vehicle 1 indicated by the vehicle periphery information i2. Therefore, in the present embodiment, the processing proceeds to S2070 in a case where the object around the vehicle 1 indicated by the vehicle periphery information i2 is located on the travel route RT. Additionally, the processing may proceed to S2070 in a case where a distance from the vehicle 1 to the object is smaller than a reference distance determined according to the vehicle speed.

In S2070, a signal SIG1 is output in response to the determination that the travel route RT satisfies the predetermined condition in S2060 (see FIG. 1). In S2070, the CPU 61 functions as a signal output unit. The signal SIG1 is a notification signal for notifying the driver, and can cause the display apparatus 7 to perform display for an alert. Instead/additionally, the signal SIG1 may be output to a sound source for alerting by means of a warning sound. As a result, it is possible to notify the driver that it is difficult for the vehicle 1 to avoid the object around the vehicle 1 indicated by the vehicle periphery information i2.

In S2080, it is determined whether or not the vehicle 1 is traveling, as in S2000. In S2080, the CPU 61 functions as the determination unit. In a case where the vehicle 1 is traveling (in a case of Yes determination), the processing returns to S2010, and in a case where the vehicle 1 is not traveling (in a case of No determination), the processing proceeds to S2090.

In S2090, the output of the signal SIG1 is suppressed, and the processing returns to S2000. In S2090, the CPU 61 functions as a signal output suppression unit. S2090 suppresses unnecessary notification. In S2090, in a case where the signal SIG1 is not output, the output of the signal SIG1 is suppressed as it is.

The flowchart finally returns to S2000 or S2010. Therefore, the travel route RT is calculated again in S2040, that is, the travel route RT displayed on the display apparatus 7 is updated. The update may be performed at a predetermined cycle while the vehicle 1 is traveling. Therefore, even in a case where the signal SIG1 is output in S2070, the output of the signal SIG1 is suppressed in a case where the updated travel route RT no longer satisfies the condition of S2060.

FIG. 3 illustrates an example of an image IM displayed on the display apparatus 7. The image IM shows a state from the front area to the side area of the vehicle 1 based on the vehicle periphery information i2, and, at the same time, the travel route RT calculated in S2040 is superimposed on the image IM. The image IM is a perspective view of the vehicle 1 as viewed from above in the present embodiment, but may also be a top view as another embodiment, or the perspective view and the top view may be displayed in a switchable manner. For example, in a case where the driver turns his/her line of sight to the right or in a case where the head of the driver turns to the right in this state, the travel route RT is updated in S2040.

As a result, as illustrated in FIG. 4, in a case where an object OB is located on the updated travel route RT, a notification NT for an alert is displayed. The notification NT may be an icon or may include text information instead of/in addition to the icon.

According to the present embodiment, the travel route RT that can be analyzed based on the vehicle state information i1 is corrected based on the vehicle periphery information i2 and the driver state information i3. As a result, the travel route RT is calculated with high accuracy. The travel route RT is displayed on the display apparatus 7, and the driver can also change his/her driving operation by viewing the travel route RT. According to the present embodiment, it is possible to implement appropriate driving assistance in this manner.

### Second Embodiment

An aspect in which the notification NT is displayed in a case where the object around the vehicle 1 is located on the travel route RT has been exemplified in the first embodiment described above (see S2060 in FIG. 2). On the other hand, a case where another vehicle as the object is traveling toward the travel route RT is also conceivable, and in such a case, the notification NT may be required to be displayed on the display apparatus 7 even in a case where the object is not located on the travel route RT.

Therefore, as illustrated in FIG. 5, in S2040, a travel route RT′ of an object OB that is another vehicle may be further calculated based on the vehicle periphery information i2. The travel route RT′ does not have to be displayed on the display apparatus 7, but in a case where the travel route RT and the travel route RT′ intersect, it is determined that the predetermined condition is satisfied in S2060 (Yes determination), and the notification NT may be displayed in S2070.

On the other hand, in a case where the driver makes a confirmation motion (here, a motion of directing a line of sight to the object OB that is another vehicle is made), the display of the notification NT may be suppressed.

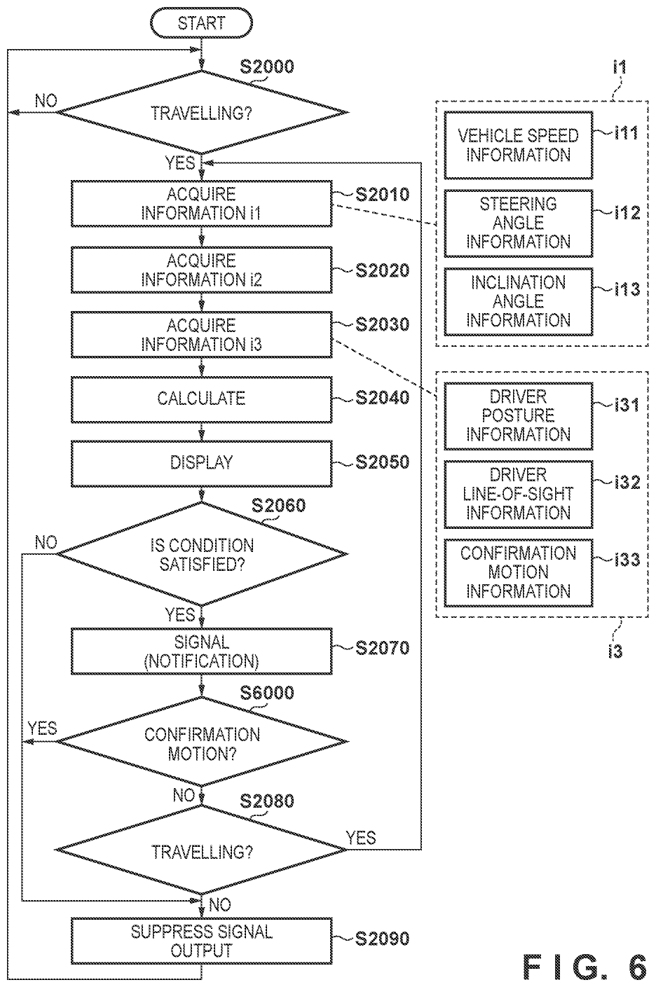

FIG. 6 illustrates a flowchart of computational processing according to the second embodiment similarly to the first embodiment (FIG. 2). The driver state information i3 acquired based on the monitoring result of the driver monitoring apparatus 52 in S2030 further includes confirmation motion information i33. The confirmation motion information i33 indicates whether or not the confirmation motion is made by the driver.

In S6000, it is determined whether the confirmation motion is made by the driver based on the confirmation motion information i33. In a case where the confirmation motion is made (Yes determination), the processing proceeds to S2090, and the output of the signal SIG1 for displaying the notification NT is suppressed. On the other hand, in a case where the confirmation motion is not made (No determination), the processing proceeds to S2080.

In the present embodiment, the computational processing in a case where the travel route RT of the self-vehicle 1 and the travel route RT ‘of another vehicle as the object OB intersect has been exemplified, but the computational processing is also applicable to the first embodiment. For example, the notification NT may be displayed in a case where the object OB is located on the travel route RT, and the display of the notification NT may be suppressed in a case where the driver makes the confirmation motion for the object OB.

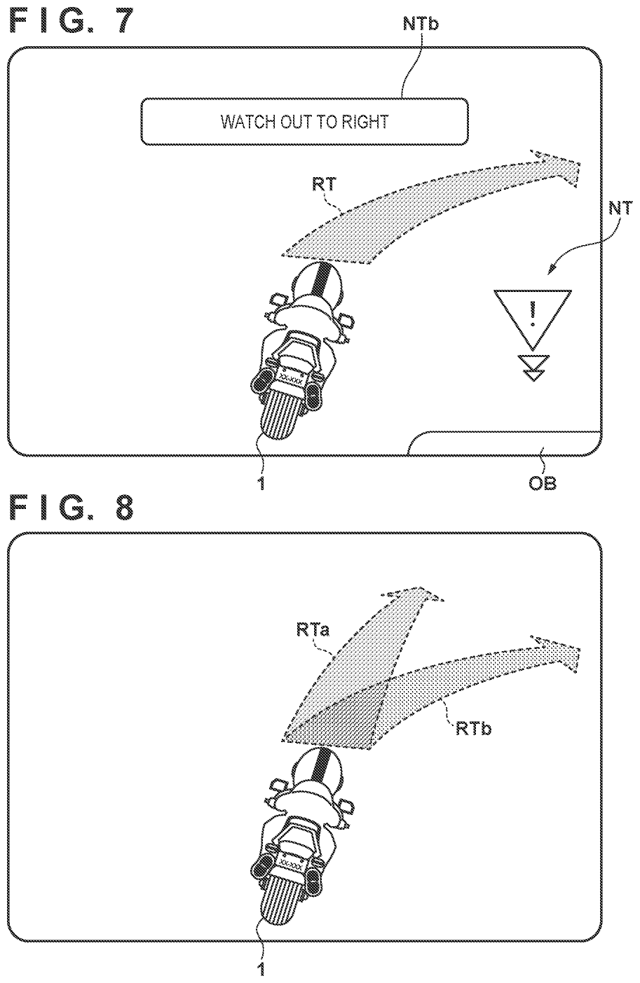

As another embodiment, in a case where the confirmation motion is not made for a predetermined period, another signal having a higher notification level than the signal SIG1 may be output, and as illustrated in FIG. 7, a more conspicuous notification NTb may be displayed on the display apparatus 7. As a result, it is possible to more effectively alert the driver. A warning sound may be output instead of/in addition to the notification NTb.

### Third Embodiment

In the first embodiment described above, in S2040, the analysis result based on the pieces of information i11 to i13 of the vehicle state information i1 is corrected based on the vehicle periphery information i2 and the driver state information i3, and the travel route RT is calculated. However, the travel route RT displayed on the display apparatus 7 is not limited to the example of the first embodiment.

FIG. 8 illustrates an example of an image IM according to the third embodiment. Here, an actual travel route RT obtained by correcting, based on the vehicle periphery information i2, the analysis result based on the pieces of information i11 to i13 of the vehicle state information i1 is defined as an actual route RTa. Further, the travel route RT obtained by correcting the actual route RTa based on the driver state information i3 is defined as a predicted route RTb. That is, it can be said that the vehicle 1 travels along the actual route RTa according to an actual traveling environment based on the vehicle state information i1 and the vehicle periphery information i2. On the other hand, it can be said that the vehicle 1 can travel along the predicted route RTb, considering the state of the driver based on the driver state information i3.

The actual route RTa and the predicted route RTb may be individually displayed on the display apparatus 7, or the display of the predicted route RTb may be omitted (only the actual route RTa may be displayed). In such a case, in S2060 (see FIG. 2), it is determined whether or not the predicted route RTb satisfies a predetermined condition, and the notification NT may be displayed based on the determination result.

In the above description, to facilitate understanding, each element is indicated by a name related to its functional aspect, but each element is not limited to an element that has the content described in the embodiment as a main function, and may be element that has supplementary content. Each element is, therefore, not strictly limited by its functional expression, which may be replaced with a similar expression. For example, an expression “apparatus” may be replaced with “unit”, “component”, “piece”, “member”, “structure”, “assembly”, or the like, or may be omitted.

### SUMMARY OF THE EMBODIMENTS

Some features of the embodiments are summarized as follows: A first aspect is a computation apparatus (6), for computing a travel route (RT) of a vehicle (1), the computation apparatus comprising:
an acquisition unit (S2010-2030) configured to acquire vehicle state information (i1) indicating a state of the vehicle, vehicle periphery information (i2) indicating a state around the vehicle, and driver state information (i3) indicating a state of a driver of the vehicle;
a calculation unit (S2040) configured to calculate the travel route of the vehicle based on the vehicle state information, the vehicle periphery information, and the driver state information; and a signal output unit (S2070) configured to output a signal (SIG1) in a case where the travel route satisfies a predetermined condition.

In the embodiment, the travel route that can be analyzed based on the vehicle state information is corrected based on the vehicle periphery information and the driver state information. As a result, the travel route can be calculated with high accuracy, and appropriate driving assistance can be implemented.

In a second aspect, the driver state information includes
driver posture information (i31) indicating a posture of the driver, and
driver line-of-sight information (i32) indicating a direction of a line of sight of the driver.

As a result, the travel route can be calculated with high accuracy.

In a third aspect, the signal output unit outputs the signal in a case where an object (OB) around the vehicle indicated by the vehicle periphery information is located on the travel route.

Accordingly, it is possible to issue an alert for an object.

In a fourth aspect, the object includes another vehicle around the vehicle and/or an on-road installation.

As a result, it is possible to issue an alert for another vehicle and/or an on-road installation.

In a fifth aspect, the acquisition unit acquires the vehicle state information based on a monitoring result of a monitoring apparatus (51) installed on the vehicle.

As a result, it is possible to appropriately acquire the vehicle periphery information.

In a sixth aspect, the acquisition unit acquires the vehicle state information based on map information.

As a result, it is possible to appropriately acquire the vehicle periphery information.

In a seventh aspect, the acquisition unit acquires the driver state information based on a monitoring result of a second monitoring apparatus (52) installed on the vehicle.

As a result, it is possible to appropriately acquire the driver state information.

In an eighth aspect, the signal which is output from the signal output unit is a notification signal for notifying the driver.

Accordingly, the driver is alerted.

In a ninth aspect, the acquisition unit further acquires confirmation motion information (i33) indicating whether or not a confirmation motion is made by the driver, the signal output unit suppresses the output of the signal based on the confirmation motion information after outputting the signal

Accordingly, an unnecessary alert is suppressed.

In a tenth aspect, the confirmation motion includes a motion of directing the line of sight of the driver to the object (OB) around the vehicle indicated by the vehicle periphery information.

As a result, the above-described ninth aspect is appropriately implemented.

In an eleventh aspect, in a case in which the signal output by the signal output unit is set as a first notification signal (SIG1) for notifying the driver, and the confirmation motion is not made for a predetermined period, the signal output unit further outputs a second notification signal for notifying the driver, the second notification signal having a higher notification level than the first notification signal.

As a result, it is possible to more effectively issue an alert.

In a twelfth aspect, the calculation unit updates the travel route at a predetermined cycle based on the vehicle state information, the vehicle periphery information, and the driver state information, and the signal output unit suppresses the output of the signal in a case where the updated travel route no longer satisfies the predetermined condition after outputting the signal.

Accordingly, an unnecessary alert is suppressed.

In a thirteenth aspect, the vehicle state information includes information (i11) indicating a speed of the vehicle, information (i12) indicating a steering angle of the vehicle, and information (i13) indicating an inclination of a vehicle body of the vehicle.

As a result, the vehicle state information can be appropriately acquired.

A fourteenth aspect is a vehicle (1), comprising the above computation apparatus (6), and a wheel (2).

That is, the above-described computation apparatus is applicable to a typical vehicle.

In a fifteenth aspect, the vehicle is a two-wheeled vehicle.

That is, the above-described computation apparatus is applicable to a typical two-wheeled vehicle.

In a sixteenth aspect, the computation apparatus further comprises a display apparatus (7) connected to the computation apparatus and configured to display the travel route.

As a result, the travel route can be visually recognized.

In a seventeenth aspect, the display apparatus performs display for notifying the driver based on the signal output by the signal output unit.

Accordingly, the alert can be visually recognized.

The invention is not limited to the foregoing embodiments, and various variations/changes are possible within the spirit of the invention.

1. A computation apparatus for computing a travel route of a vehicle, the computation apparatus comprising:
an acquisition unit configured to acquire vehicle state information indicating a state of the vehicle, vehicle periphery information indicating a state around the vehicle, and driver state information indicating a state of a driver of the vehicle;
a calculation unit configured to calculate the travel route of the vehicle based on the vehicle state information, the vehicle periphery information, and the driver state information; and
a signal output unit configured to output a signal in a case where the travel route satisfies a predetermined condition,
wherein the acquisition unit further acquires confirmation motion information indicating whether or not a confirmation motion is made by the driver,
the signal output unit suppresses the output of the signal based on the confirmation motion information after outputting the signal, and
in a case in which the signal output by the signal output unit is set as a first notification signal for notifying the driver, and the confirmation motion is not made for a predetermined period, the signal output unit further outputs a second notification signal for notifying the driver, the second notification signal having a higher notification level than the first notification signal.

2. The computation apparatus according to claim 1, wherein
the driver state information includes
driver posture information indicating a posture of the driver, and
driver line-of-sight information indicating a direction of a line of sight of the driver.

3. The computation apparatus according to claim 1, wherein the signal output unit outputs the signal in a case where an object around the vehicle indicated by the vehicle periphery information is located on the travel route.

4. The computation apparatus according to claim 1, wherein the confirmation motion includes a motion of directing the line of sight of the driver to the object around the vehicle indicated by the vehicle periphery information.

5. The computation apparatus according to claim 1, wherein the calculation unit updates the travel route at a predetermined cycle based on the vehicle state information, the vehicle periphery information, and the driver state information, and the signal output unit suppresses the output of the signal in a case where the updated travel route no longer satisfies the predetermined condition after outputting the signal.

6. The computation apparatus according to claim 1, wherein the vehicle state information includes information indicating a speed of the vehicle, information indicating a steering angle of the vehicle, and information indicating an inclination of a vehicle body of the vehicle.

7. A vehicle comprising
a computation apparatus for computing a travel route of a vehicle; and a wheel,
the computation apparatus comprising:
an acquisition unit configured to acquire vehicle state information indicating a state of the vehicle, vehicle periphery information indicating a state around the vehicle, and driver state information indicating a state of a driver of the vehicle;
a calculation unit configured to calculate the travel route of the vehicle based on the vehicle state information, the vehicle periphery information, and the driver state information; and
a signal output unit configured to output a signal in a case where the travel route satisfies a predetermined condition,
wherein the acquisition unit further acquires confirmation motion information indicating whether or not a confirmation motion is made by the driver,
the signal output unit suppresses the output of the signal based on the confirmation motion information after outputting the signal, and
in a case in which the signal output by the signal output unit is set as a first notification signal for notifying the driver, and the confirmation motion is not made for a predetermined period, the signal output unit further outputs a second notification signal for notifying the driver, the second notification signal having a higher notification level than the first notification signal.

8. The vehicle according to claim 7, further comprising
a display apparatus connected to the computation apparatus and configured to display the travel route,
wherein the display apparatus performs display for notifying the driver based on the signal output by the signal output unit.
